(19) United States
(12) Patent Application Publication
(10) Pub. No.: US 2015/0105894 A1
(43) Pub. Date: Apr. 16, 2015

(54) COMPUTING DEVICE AND METHOD FOR VALIDATING CNC PRODUCTION CAPABILITY

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); LU YANG, Shenzhen (CN)

(21) Appl. No.: 14/513,229

(22) Filed: Oct. 14, 2014

(30) Foreign Application Priority Data
Oct. 15, 2013 (CN) 201310479822.8

(51) Int. Cl. G05B 19/414

(52) U.S. Cl. CPC G05B 19/4145; G05B 2219/32368
USPC 700/110

(57) ABSTRACT

A method for validating computer numerical control (CNC) production capability is applied in a computing device. The CNC machine produces a predetermined number of products. A scanner scans each product to obtain a point cloud of each product. The computing device selects one point cloud of one product as a base point cloud, and fits a geometry based on the base point cloud. The computing device calculates a deviation between each point in each other point cloud and the geometry, and determines whether the production capability of the CNC machine is qualified according to calculated deviations.

### CROSS-REFERENCE TO RELATED APPLICATIONS

This application claims priority to Chinese Patent Application No. 201310479822.8 filed on Oct. 15, 2013, the contents of which are incorporated by reference herein.

### FIELD

The subject matter herein generally relates to computer aided control.

### BACKGROUND

Inspectors can determine whether computer numerical control (CNC) production capability of a CNC machine is qualified by manually detecting products produced by the CNC machine based on experience. The determination may be unreliable and inaccurate. Therefore, reliable and accurate validation of CNC production capability is desirable.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a CNC production capability validating system.

FIG. 2 is a flowchart of one example embodiment of a CNC production capability validating method.

FIG. 3 illustrates one embodiment of a geometry fitted based on a point cloud.

FIG. 4 illustrates one embodiment of deviations between a geometry fitted based on a point cloud and points in another point cloud, and vectors from the points to the geometry.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

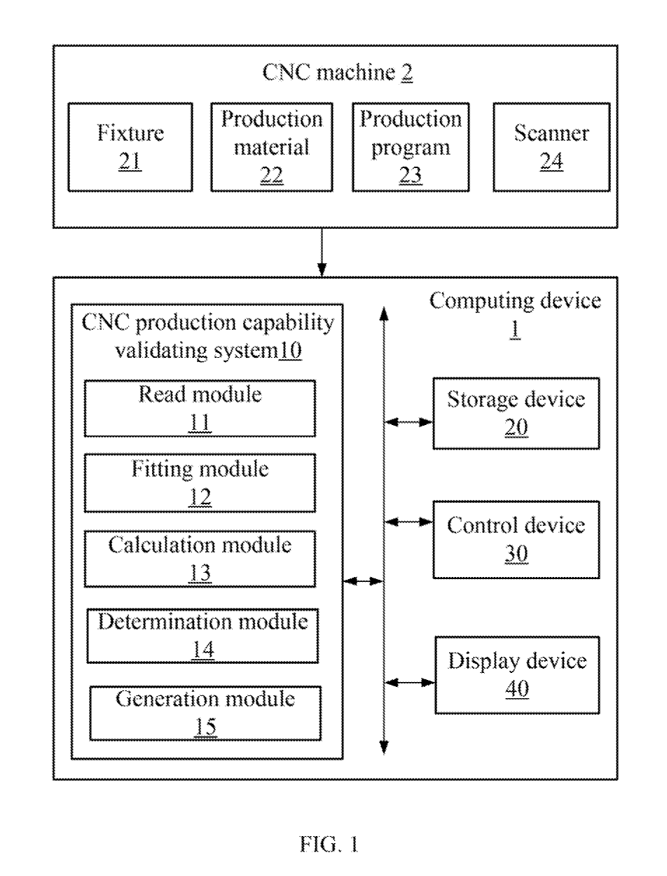

FIG. 1 is a block diagram of one example embodiment of a hardware environment for executing a computer numerical control (CNC) production capability validating system 10. The CNC production capability validating system 10 is installed and run in a computing device 1. The computing device 1 can be connected to a CNC machine 2. The computing device 1 can include a storage device 20, at least one control device 30, and a display device 40. The CNC machine 2 can include a fixture 21, a production material 22, a production program 23, and a scanner 24.

The fixture 21 is used to fix the production material 22. In one embodiment, the fixture 21 can be a fastening component that fixes the production material 22.

The production program 23 is run by the CNC machine 2 to process the production material 22 to produce products.

The scanner 24 scans a surface of each product produced by the CNC machine 2 to obtain a point cloud consisting of a large number of points on the surface of the product. The scanner 24 can be a laser scanner.

The CNC machine 2 can further include other components not shown in FIG. 1, such as a cutting tool used to cut the production material 22, a platform used to support the production material 11, and a storage unit that stores the production program 23 and data produced by the scanner 24 and the CNC machine 2.

The CNC production capability validating system 10 can include a plurality of function modules. The function modules 11-15 can include computerized codes in the form of one or more programs, which provide at least the functions of the CNC production capability validating system 10. In one embodiment, the CNC machine 2 processes the production material 22 to produce a predetermined number of products. The scanner 24 scans a surface of each product to obtain a point cloud of each product. The CNC production capability validating system 10 selects the point cloud of one product as a base point cloud, fits a geometry based on the base point cloud, and calculates a deviation between each point in each other point cloud and the geometry. According to deviations between points in each other point cloud and the geometry, the CNC production capability validating system 10 determines whether the production capability of the CNC machine is qualified, and outputs a report to store the storage device 20 or display on the display device 40.

The storage device 20 can include some type(s) of non-transitory computer-readable storage medium such as, for example, a hard disk drive, a compact disc, a digital video disc, or a tape drive. The storage device 20 stores the computerized codes of the function modules of the CNC production capability validating system 10.

The control device 30 can be a processor, an application-specific integrated circuit (ASIC), or a field programmable gate array (FPGA), for example. The control device 30 can execute computerized codes of the function modules of the CNC production capability validating system 10 to realize the functions of the computing device 1.

In one embodiment, the CNC production capability validating system 10 includes a read module 11, a fitting module 12, a calculation module 13, a determination module 14, and a generation module 15.

The read module 11 is configured to read point clouds of a predetermined number of products from the scanner 24 and store the point clouds in the storage device 20. As mentioned above, the predetermined number of products are produced by the CNC machine 2. The scanner 24 scans a surface of each product to obtain a point cloud of each product.

The fitting module 12 is configured to select one point cloud of one of the products as a base point cloud, and fit a geometry based on the base point cloud. The geometry can be a curve or a surface. In one embodiment, the fitting module 12 can use a method of least squares, in conjunction with the quasi-Newton iterative algorithm, to fit the geometry.

The calculation module 13 is configured to calculate a deviation between each point in each other point cloud and the geometry, and determine a vector from each point in each other point cloud to the geometry according to the deviation. The calculation module 13 can calculate the deviation between each point in each other point cloud and the geometry by calculating a closest distance from each point in each other point cloud to the geometry. For example, the absolute value of the deviation can be equal to the closest distance.

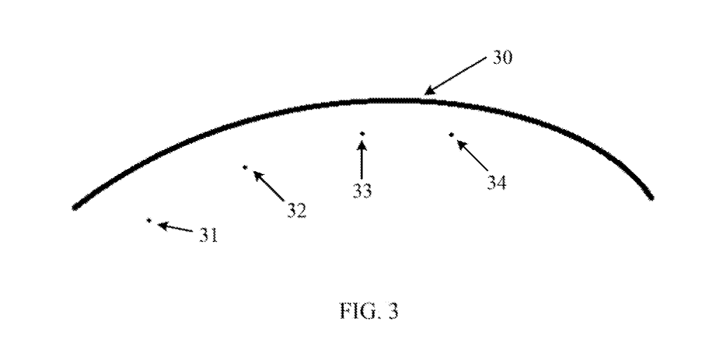

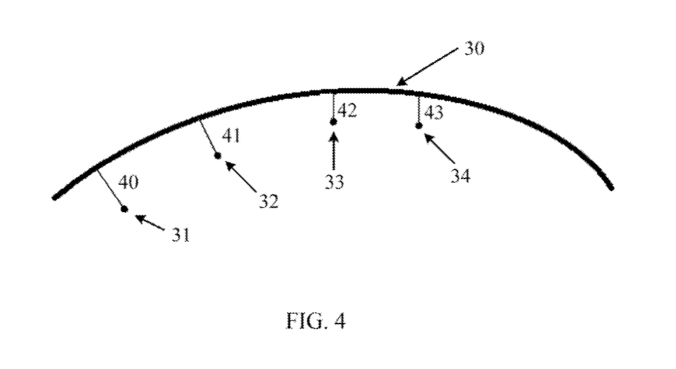

FIG. 3 illustrates one embodiment of a geometry fitted based on a point cloud. In this embodiment, the fitted geometry is a curve 30. Discrete points 31, 32, 33, and 34 are points in another point cloud. FIG. 4 illustrates one embodiment of deviations between a geometry fitted based on a point cloud and points in another point cloud, and vectors from the points to the geometry. In this embodiment, lines 40, 41, 42, and 43 depict the deviations between the discrete points 31-34 and the curve 30 and vectors from the discrete points 31-34 to the curve 30.

The determination module 14 is configured to determine a first deviation having a maximum absolute value and a second deviation having a minimum absolute value from all deviations, calculate a sum of the maximum absolute value and the minimum absolute value, and determine whether the production capability of the CNC machine 2 is qualified according to the sum. For example, the maximum absolute value is denoted as |max|, the minimum absolute value is denoted as |min|, the production capability of the CNC machine 2 is |max|+|min|. If |max|+|min| is greater than a preset value, the production capability of the CNC machine 2 is determined as being qualified. Otherwise, if |max|+|min| is equal to or less than the preset value, the production capability of the CNC machine 2 is determined as being unqualified.

The generation module 15 is configured to generate a report to depict the deviation between each point in each other point cloud and the geometry and/or the vector from each point in each other point cloud to the geometry, and display the report on the display device 40. In one embodiment, the report is represented as a graph including the geometry and each point in each other point cloud. The generation module 15 can specify multiple deviation ranges and assign a unique color for each deviation range. If a deviation between a point and the geometry falls into a certain deviation range, the point in the graph is highlighted with the color assigned for the certain deviation range. A vector from the point to the geometry (such as the line 40 in FIG. 4) can also be highlighted with the color assigned to the certain deviation range.

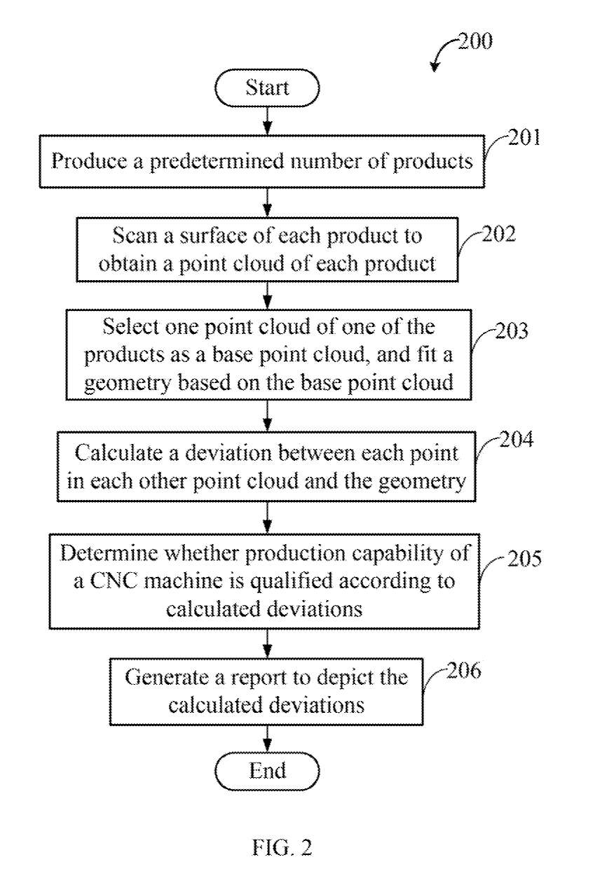

FIG. 2 is a flowchart of one example embodiment of a CNC production capability validating method. In the embodiment, the method is performed by execution of computer-readable software program codes or instructions by the control device 30, such as at least one processor of the computing device 1.

Referring to FIG. 2, a flowchart is presented in accordance with an example embodiment. The method 200 is provided by way of example, as there are a variety of ways to carry out the method. The method 200 described below can be carried out using the configurations illustrated in FIG. 1, for example, and various elements of these figures are referenced in explaining method 200. Each block shown in FIG. 2 represents one or more processes, methods, or subroutines, carried out in the method 200. Furthermore, the illustrated order of blocks is illustrative only and the order of the blocks can be changed. Additional blocks can be added or fewer blocks may be utilized without departing from this disclosure. The method 200 can begin at block 201.

At block 201, a CNC machine runs a production program to process a production material fixed on a fixture, to produce a predetermined number of products. For example, the CNC machine can produce 32 same products.

At block 202, a scanner scans a surface of each product to obtain a point cloud of each product. A read module reads the point cloud of each product from the scanner and stores the point cloud of each product in a storage device.

At block 203, a fitting module selects one point cloud of one of the products as a base point cloud, and fits a geometry based on the base point cloud.

At block 204, a calculation module calculates a deviation between each point in each other point cloud and the geometry, and determines a vector from each point in each other point cloud to the geometry according to the deviation.

At block 205, a determination module determines a first deviation having a maximum absolute value and a second deviation having a minimum absolute value from all deviations, calculates a sum of the maximum absolute value and the minimum absolute value, and determines whether the production capability of the CNC machine is qualified according to the sum.

At block 206, a generation module generates a report to depict the deviation between each point in each other point cloud and the geometry and/or the vector from each point in each other point cloud to the geometry, and displays the report on a display device.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A method for validating computer numerical control (CNC) production capability of a CNC machine, the method comprising:
producing a predetermined number of products by the CNC machine;
scanning a surface of each of the products to obtain a point cloud of each of the products by a scanner;
reading the point cloud of each of the products from the scanner by a computing device;
selecting one point cloud of one of the products as a base point cloud;
fitting a geometry based on the base point cloud by the computing device;
calculating a deviation between each point in each other point cloud and the geometry by the computing device;
determining a first deviation having a maximum absolute value and a second deviation having a minimum absolute value from all deviations;
calculating a sum of the maximum absolute value and the minimum absolute value; and
determining whether the production capability of the CNC machine is qualified according to the sum.

2. The method according to claim 1, further comprising:
generating a report to depict the deviation between each point in each other point cloud and the geometry, and displaying the report on a display device.

3. The method according to claim 1, wherein the geometry is fitted using a method of least squares.

4. The method according to claim 1, wherein the deviation between each point in each other point cloud and the geometry is calculated by calculating a closest distance from each point in each other point cloud to the geometry.

5. The method according to claim 1, wherein the report is represented as a graph comprising the geometry and each point in each other point cloud.

6. The method according to claim 5, wherein each point in each other point cloud in the graph is highlighted with a specified color.

7. A computing device comprising:
a control device; and
a storage device storing one or more programs which when executed by the control device, causes the control device to perform operations comprising:
reading point cloud of a predetermined number of products, wherein the predetermined number of products are produced by a computer numerical control (CNC) machine, and the point clouds are obtained by scanning a surface of each of the products;
selecting one point cloud of one of the products as a base point cloud;
fitting a geometry based on the base point cloud;
calculating a deviation between each point in each other point cloud and the geometry;
determining a first deviation having a maximum absolute value and a second deviation having a minimum absolute value from all deviations;
calculating a sum of the maximum absolute value and the minimum absolute value; and
determining whether the production capability of the CNC machine is qualified according to the sum.

8. The computing device according to claim 7, wherein the operations further comprise:
generating a report to depict the deviation between each point in each other point cloud and the geometry, and displaying the report on a display device.

9. The computing device according to claim 7, wherein the geometry is fitted using a method of least squares.

10. The computing device according to claim 7, wherein the deviation between each point in each other point cloud and the geometry is calculated by calculating a closest distance from each point in each other point cloud to the geometry.

11. The computing device according to claim 7, wherein the report is represented as a graph comprising the geometry and each point in each other point cloud.

12. The computing device according to claim 11, wherein each point in each other point cloud in the graph is highlighted with a specified color.

13. A non-transitory storage medium having stored thereon instructions that, when executed by a control device of a computing device, causes the control device to perform a method for validating computer numerical control (CNC) production capability of a CNC machine, the method comprising:
reading point clouds of a predetermined number of products, wherein the predetermined number of products are produced by the CNC machine, and the point clouds are obtained by scanning a surface of each of the products;
selecting one point cloud of one of the products as a base point cloud;
fitting a geometry based on the base point cloud;
calculating a deviation between each point in each other point cloud and the geometry;
determining a first deviation having a maximum absolute value and a second deviation having a minimum absolute value from all deviations;
calculating a sum of the maximum absolute value and the minimum absolute value; and
determining whether the production capability of the CNC machine is qualified according to the sum.

14. The non-transitory storage medium according to claim 13, wherein the method further comprises:
generating a report to depict the deviation between each point in each other point cloud and the geometry, and displaying the report on a display device.

15. The non-transitory storage medium according to claim 13, wherein the geometry is fitted using a method of least squares.

16. The non-transitory storage medium according to claim 13, wherein the deviation between each point in each other point cloud and the geometry is calculated by calculating a closest distance from each point in each other point cloud to the geometry.

17. The non-transitory storage medium according to claim 13, wherein the report is represented as a graph comprising the geometry and each point in each other point cloud.

18. The non-transitory storage medium according to claim 17, wherein each point in each other point cloud in the graph is highlighted with a specified color.
